(19) United States
(12) Patent Application Publication
(10) Pub. No.: US 2012/0042588 A1
(43) Pub. Date: Feb. 23, 2012

(54) INTEGRATED PHOTOVOLTAIC MODULE

(75) Inventor: Robert Warren Erickson, JR., Boulder, CO (US)

(73) Assignee: The Regents of the University of Colorado, Denver, CO (US)

(21) Appl. No.: 13/318,589

(22) PCT Filed: May 10, 2010
(86) PCT No.: PCT/US10/34260

§ 371 Date: Nov. 2, 2011

Related U.S. Application Data
(60) Provisional application No. 61/177,091, filed on May 11, 2009.

(51) Int. Cl. E04D 13/18; H02J 1/00; H02M 3/335

(52) U.S. Cl. 52/173.3; 363/17; 307/43

(57) ABSTRACT

The disclosed embodiments increase the power generated by a photovoltaic (PV) array, when the PV panels within the PV array are not uniformly illuminated or oriented or when PV panels are mismatched (e.g., have varying performance characteristics) and/or operate at non-uniform temperatures. It also provides simpler interconnection and wiring of the elements (e.g., PV panels) of the array. A dc-dc converter comprised of a DC transformer is coupled to each PV panel in a photovoltaic array to generate an increased dc voltage from a lower dc voltage produced by the PV panel. The outputs of the dc-dc converters are connected in parallel to a dc bus, which distributes the resulting voltage. As a result, the energy generated by the PV array is increased, the costs of system design and installation are reduced, and it becomes feasible to install PV arrays in new locations such as on gabled or non-planar roofs.

### BACKGROUND

1. Field of Art

This disclosure relates generally to the field of photovoltaic power systems. More specifically, this disclosure relates to integrated photovoltaic modules that include highly efficient dc-dc conversion circuitry that improves energy capture of a photovoltaic array.

2. Description of the Related Art

Solar photovoltaic (PV) cells typically produce dc voltages of less than one volt. The amount of electrical power produced by such a cell is equal to its dc voltage multiplied by its dc current, and these quantities depend on multiple factors including the solar irradiance, cell temperature, process variations and cell electrical operating point. It is commonly desired to produce more power than can be generated by a single cell, and hence multiple cells are employed. It is also commonly desired to supply power at voltages substantially higher than the voltage generated by a single cell. Hence, multiple cells are typically connected in series.

For example, consider a conventional rooftop solar power system 100 such as that illustrated in FIG. 1. The illustrated system 100 is a 5 kW (grid-tied) rooftop solar PV power system that delivers its power to a 240 V ac utility. Because of the very large number of PV cells required in a typical application such as system 100, the individual PV cells are typically packaged into intermediate-sized panels such as the conventional PV panels of FIG. 1. Conventional PV panels typically have several tens (or more) series-connected PV cells and typically produce several tens of volts dc. These panels also typically include one or more bypass diodes 106a, 106b, 106c, 106d mounted on the backplane of the panel, as shown in FIG. 1. For the sake of example, each conventional PV panel 105a, 105b, 105c, 105d of FIG. 1 includes ninety-six series-connected PV cells, allowing each conventional PV panel 105a, 105b, 105c, 105d to produce approximately 55 volts dc. Hence, a series string of seven conventional PV panels produces approximately 385 volts dc. In the conventional system 100 of FIG. 1, conventional PV panel 105a and conventional PV panel 105b are part of a seven-panel string, but the five intermediate conventional PV panels coupled between conventional PV panel 105a and conventional PV panel 105b are not shown, for visual clarity. Similarly, conventional PV panel 105c and conventional PV panel 105d are also part of a seven-panel string, but the five intermediate conventional PV panels coupled between conventional PV panel 105c and conventional PV panel 105d are not shown, for visual clarity Conventional PV panels that include other numbers of series-connected PV cells are possible. Other numbers of conventional PV panels can also be connected in a series string.

The outputs of the two seven-panel series strings of conventional PV panels are connected through a combiner 110 circuit to the input of a central dc-ac inverter 115. The inverter 115 changes the high voltage dc (e.g., 400 V) generated by the series-connected conventional PV panels into 240 V ac as required by the utility. In addition, the inverter 115 performs certain grid interface functions as required by standards (such as IEEE Standard 1547) and building codes, which may include anti-islanding, protection from ac line transients, galvanic isolation, production of ac line currents meeting harmonic limits, and other functions.

In the conventional system 100, the inverter 115 can include a DC-DC conversion module 120 and an ac interface module 125. Control circuitry for the inverter 115 can implement a maximum power point tracking (MPPT) algorithm. Many MPPT algorithms are known in the art. The dc-dc conversion module 120 includes dc-dc conversion circuitry and can serve as a central dc-dc converter for the output of the multiple conventional PV panels 105a, 105b, 105c, 105d included in the system 100. Control circuitry within the inverter 115 can control the dc-dc conversion module 120 to adjust the voltage at the input to the inverter 115 to maximize the power that flows through the inverter 115. The inverter 115 also includes an ac interface module 125 (typically a dc-ac converter) to interface to an ac utility grid.

As noted above, the power produced by a conventional PV panel depends on the voltage and current of the conventional PV panel and also on other factors including solar irradiation and temperature. The maximum current that a conventional PV panel can produce (the “short circuit current”) is proportional to the solar irradiation incident on the conventional PV panel. When conventional PV panels are connected in series (in a “series string” such as conventional PV panel 105a and conventional PV panel 105b), each of the conventional PV panels must conduct the same current (the “string current”). For example, the series string including conventional PV panel 105a and conventional PV panel 105b can be considered. If conventional PV panel 105a is partially shaded, then the current of all conventional PV panels in the string that includes conventional PV panels 105a, 105b is affected. In some instances, the series string operates with a reduced current determined by the current of the shaded conventional PV panel 105a, reducing the power generated by all conventional PV panels in the string. Alternatively, the string may conduct a larger current, causing the bypass diode 106a of the shaded conventional PV panel 105a to conduct, so that no power is harvested from the shaded conventional PV panel 105a and additionally the total voltage produced by the string is reduced. In either case, the system 100 produces less than the maximum possible power.

Additionally, the dc-dc conversion module 120 included in the inverter 115 typically operates with less than 100% efficiency, and some fraction of the power generated by the collection of PV panels (referred to as a photovoltaic array) is therefore lost.

Several approaches to increase the power generated by PV cells under non-uniform illumination conditions have been proposed. One approach, illustrated in FIG. 2, employs a small inverter connected externally to each conventional PV panel 105, commonly referred to as a microinverter 215. The microinverter 215 can include a dc-dc conversion module 220 and MPPT control circuitry (not shown) to operate the corresponding conventional PV panel 105 at the dc current that maximizes the output power of the conventional PV panel 105 or of ac interface module 225. FIG. 2 illustrates the block diagram of a microinverter 215 that interfaces a single conventional PV panel 105 to the ac utility.

In the microinverter 215 approach, an array containing one hundred conventional PV panels 105 would include one hundred externally coupled microinverters 215, each operating the corresponding conventional PV panel 105 at the point that maximizes the power generated by the individual conventional PV panel 105. Thus, partial shading of one conventional PV panel 105 does not disrupt the power generated by an adjacent conventional PV panel 105. The microinverter 215 allows conventional PV panels 105 to be connected to the grid using standard ac wiring. However, each microinverter 215 must be designed to operate at the high temperatures encountered on rooftops, while simultaneously meeting ac grid interface requirements. As a result, the per-panel microinverter 215 approach can be prohibitively expensive and unreliable.

Another approach, illustrated in FIG. 3, is referred to as the series-connected module-integrated converter (MIC) approach. In the MIC approach, conventional dc-dc converters 230a, 230b, 230c, 203d are coupled to each conventional PV panel 105a, 105b, 105c, 105d, respectively. These converters 230a, 230b, 230c, 203d are capable of changing the dc current and voltage, so that current for an individual conventional PV panel 105 can differ from the string current (e.g. the current of conventional PV panel 105a can differ from that of conventional PV panel 105b). The MIC approach of FIG. 3 leads to a variable dc string voltage. Also, some variants of the MIC approach generate a fixed voltage for each series string of conventional PV panels (e.g., the series combination that includes conventional PV panels 105a and 105b is equal to that of the series combination that includes 105c and 105d), and the inverter 415 does not include any dc-dc conversion circuitry. This approach is illustrated in FIG. 4.

However, MIC approaches such as those illustrated in FIGS. 3 and 4 are not fully adequate solutions. They require more complex wiring of both series and parallel strings of conventional PV panels, and a faulty connection in one coventional PV panel can still disrupt the operation of the other coventional PV panels in the string, potentially causing the complete string to fail (produce no current).

### SUMMARY

The disclosed embodiments and principles provide a way to increase the power generated by a solar photovoltaic (PV) array. A dc-dc converter is integrated into the PV modules comprising the PV array. The dc-dc converters modules step up a relatively low dc voltage generated by a PV cell included in an integrated PV modules to a higher dc voltage. For example, the dc-dc converter increases the dc voltage generated by a PV cell to 200 V or 400 V dc. In one embodiment, the dc-dc converter is comprised of a DC transformer circuit, including switching circuitry, a transformer, and rectifier circuitry. The transformer has a primary winding and a secondary winding. Switching circuitry couples the output of a PV panel comprised of a plurality of photovoltaic cells to the primary winding of the transformer to convert the dc voltage generated by the photovoltaic cells into a first ac voltage at the primary winding. Rectifier circuitry coupled to the secondary winding converts a second ac voltage across the secondary winding to a second dc voltage which is fed to a high-voltage bus.

In one embodiment, the outputs of multiple integrated PV modules are connected in parallel to a high-voltage bus, simplifying the wiring between integrated PV modules. A central inverter coupled to the high-voltage bus provides a grid interface between the multiple integrated PV modules and an ac utility. For example, one benefit of the resulting integrated PV modules is that they can be configured to provide maximum power point tracking on a fine scale. The integrated PV modules may be included in a building-integrated PV element such as a PV roof shingle.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an example of a conventional solar PV power generation system.

FIG. 2 illustrates an example of a conventional PV panel coupled to a microinverter.

FIG. 3 illustrates a first example of a conventional series-connected MIC solar PV power generation system.

FIG. 4 illustrates a second example of a conventional series-connected MIC solar PV power generation system.

FIG. 5 illustrates one embodiment of a PV power generation system that includes integrated PV modules.

FIG. 6A illustrates one embodiment of a dc transformer.

FIG. 6B illustrates the timing of logic signals for one embodiment of a dc transformer.

FIG. 6C illustrates magnified switching current and voltage waveforms for secondary-side components included in one embodiment of a dc transformer.

FIG. 6D illustrates switching current and voltage waveforms for primary-side and secondary-side components included in one embodiment of a dc transformer.

FIG. 7A illustrates a first embodiment of an integrated PV module.

FIG. 7B illustrates a second embodiment of an integrated PV module.

FIG. 8 illustrates a controller for one embodiment of an integrated PV module.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the Figures and may indicate similar or like functionality. The Figures depict embodiments of the disclosed system (or method) for purposes of illustration only. One skilled in the art will readily recognize from the following description that alternative embodiments of the structures and methods illustrated herein may be employed without departing from the principles described herein.

General Overview

The disclosed embodiments and principles provide a way to increase the power generated by a solar photovoltaic (PV) array, when the PV panels within the PV array are not uniformly illuminated or oriented. The disclosed embodiments and principles also increase the power generated by a solar photovoltaic array in which panels are mismatched (e.g., have varying performance characteristics) and/or operate at non-uniform temperatures. It also provides simpler interconnection and wiring of the elements (e.g., PV panels) of the array. As a result, the energy generated by the PV array is increased, the costs of system design and installation are reduced, and it becomes feasible to install PV arrays in new locations such as on gabled or non-planar roofs.

Distributed dc-dc converters are integrated into photovoltaic modules to create integrated PV modules. One benefit of the resulting integrated PV modules is that they can be configured to provide maximum power point tracking on a fine scale. The integrated PV modules can be based on traditional PV panels, or on a smaller portion of a PV panel, or on a building-integrated PV element such as a PV roof shingle. The dc-dc converters included in the integrated PV modules step up relatively low voltages generated by the PV cells included in the integrated PV modules to higher voltages such as 200 V or 400 V dc. The outputs of the integrated PV modules included in a system are connected in parallel, simplifying the wiring between modules. A central inverter provides a grid interface between the system and the ac utility.

Very low insertion loss for power electronic elements of the system (e.g., dc-dc converters) helps facilitate implementation of this approach. In one embodiment, very low insertion loss is achieved by utilizing a fixed-ratio dc transformer circuit for the dc-dc conversion circuitry of the integrated PV modules. The fixed input-to-output voltage ratio allows the dc transformer circuit to be optimized for very high efficiency. This optimization includes operation of the input-side MOSFETs of the dc transformer at maximum duty cycle and operation of the output-side diodes of the dc transformer with zero-voltage switching.

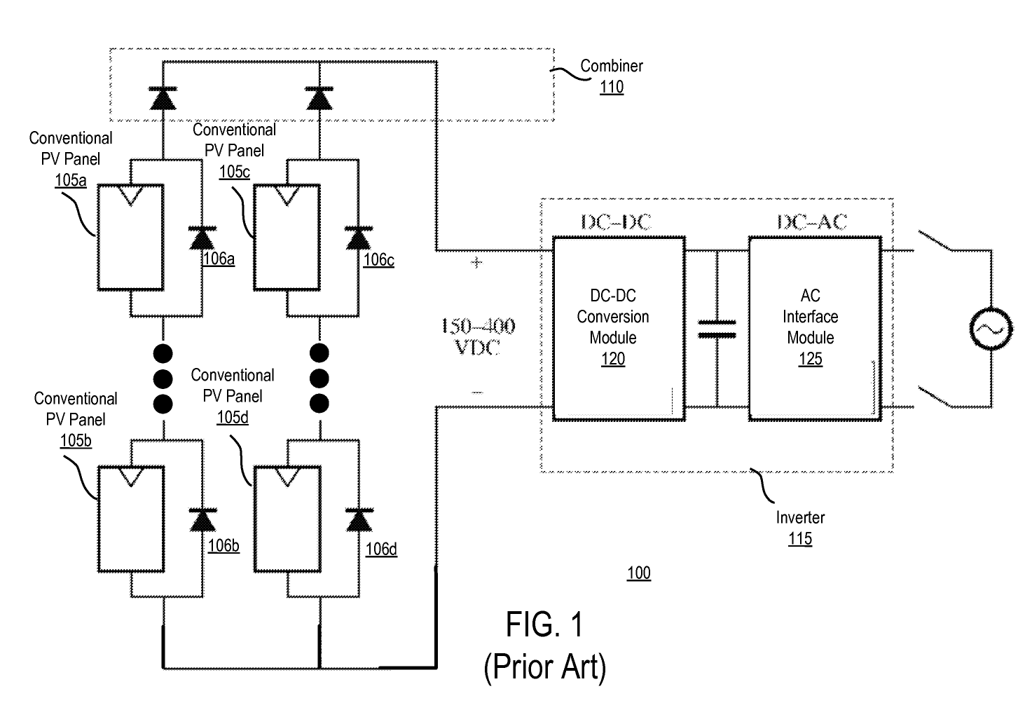

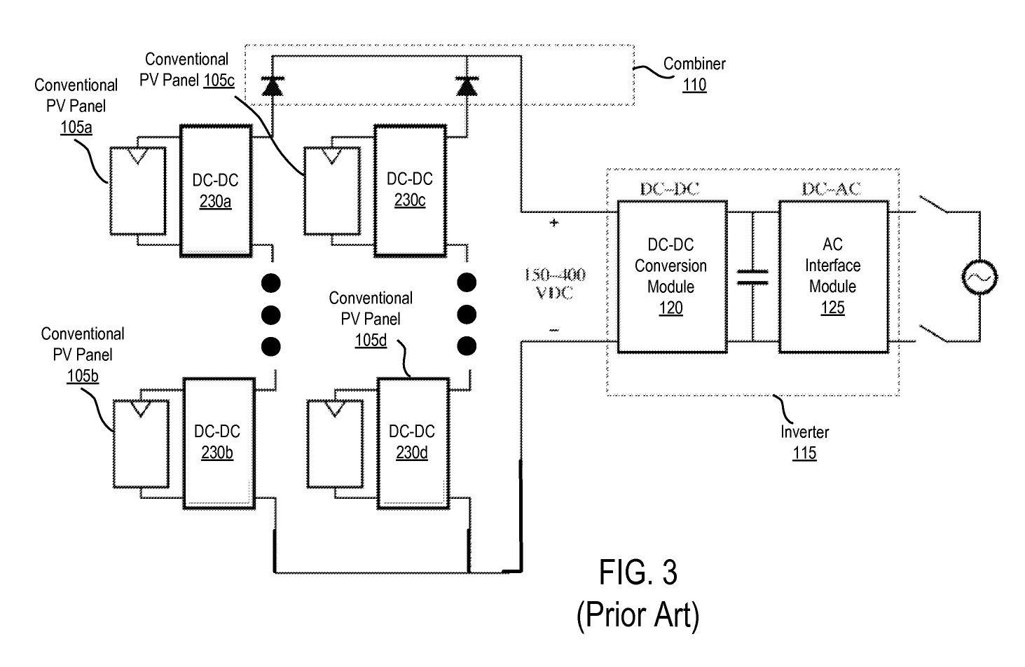

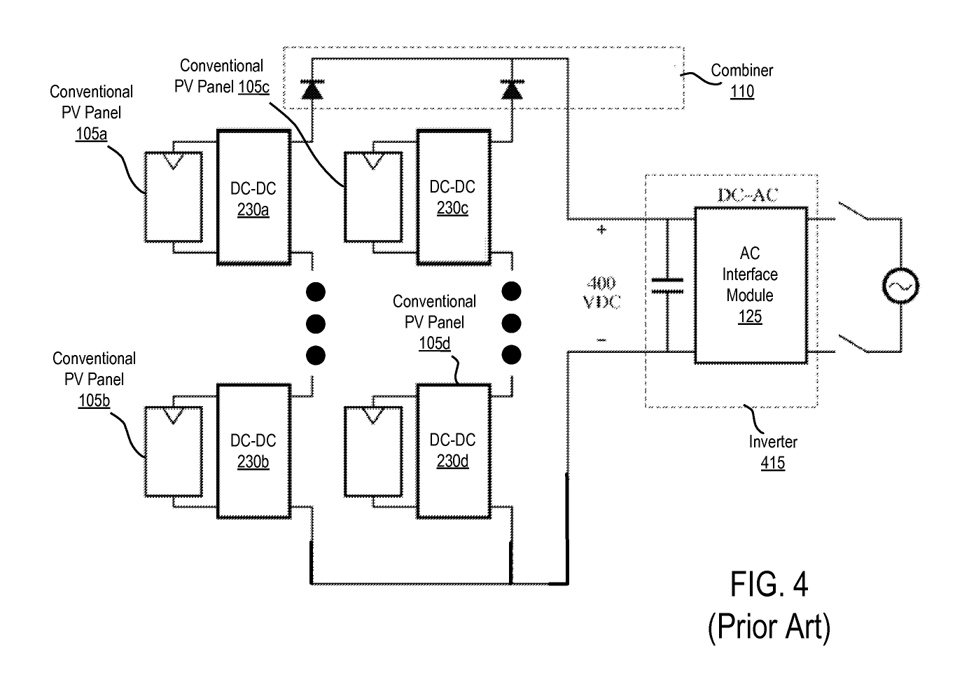

The new system of parallel-connected integrated PV modules having integrated dc-dc converters provides increased energy output when the photovoltaic array is partially shaded. The distributed dc-dc converters (e.g., dc transformers) are less expensive and more reliable than distributed microinverters 215. The parallel-connected system also leads to a simpler and less expensive installation than in conventional series-connected approaches such as those illustrated in FIGS. 1-4. The integrated PV module approach can also enable simplification of the central inverter and reduction of its loss compared to conventional systems. The central inverter can also be made more efficient by eliminating the requirement for isolation and reducing its insertion loss. The disclosed embodiments additionally provide a high-efficiency realization of the dc-dc converters, enabling practical realization of high-voltage dc integrated PV modules.

System Architecture

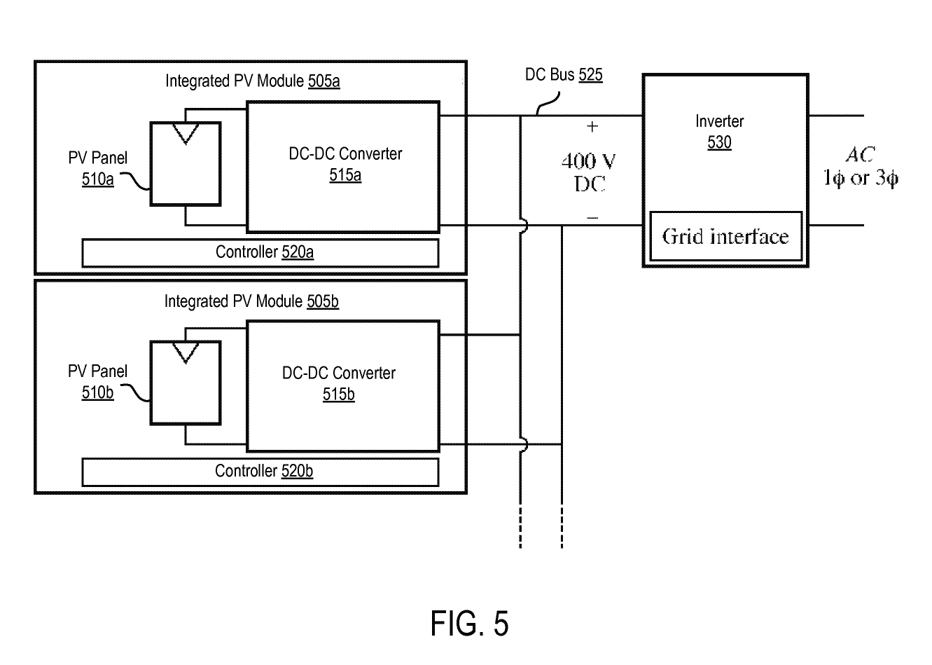

One embodiment of a parallel-connected integrated PV module is illustrated in FIG. 5 which shows at least two integrated PV modules 505a, 505b connected in parallel to a high-voltage dc bus 525. Integrated PV module 505a includes a PV panel 510a, a dc-dc converter 515a, and a controller 520a. Similarly, integrated PV module 505b includes a PV panel 510b, a dc-dc converter 515b, and a controller 520b. The dc-dc converters 515a, 515b included in the integrated PV modules 505a, 505b interface the integrated PV modules 505a, 505b to the high-voltage dc bus 525. The PV panels 510a, 510b included in the integrated PV modules 505a, 505b can be traditional PV panels including a large or small number of PV cells. The PV panels 510a, 510b can also be part of modular building-integrated PV units such as PV roof shingles. The integrated PV modules 505a, 505b can include controllers 520a, 520b that govern operation of the dc-dc converters 515a, 515b. In some embodiments, the controllers 520a, 520b also implement a local MPPT algorithm to maximize the power generated by the PV panels 510a, 510b. In simpler, lower cost implementations, MPPT functionality can be omitted from the controllers 520a, 520b. As noted above, the outputs of the dc-dc converters 515a, 515b are connected in parallel to the dc bus 515, and the dc bus 515 couples the integrated PV modules 505a, 505b to the input of the inverter 530. Typical voltages are illustrated in FIG. 5, but other voltage levels are possible.

Direct conversion from low voltage dc to high voltage dc, as proposed in FIG. 5, has been largely avoided in the past at least in part because of the unacceptably low efficiencies exhibited by conventional dc-dc converters. The embodiments described herein include step-up dc-dc converters 515a, 515b that exhibit substantially improved efficiency which allows the approach of FIG. 5 to be commercially feasible.

Since the outputs of the integrated PV modules 505a, 505b are connected in parallel, interconnection of the integrated PV modules 505 to form an array is beneficially more straightforward, cost-effective, and reliable than conventional approaches. For example, additional PV panels 510a, 510b can be easily added to the array simply by adding additional integrated PV modules connected in parallel. The number of integrated PV modules 505a, 505b and therefore PV panels 510a, 510b is only limited by the power rating of the inverter 530. Unlike conventional approaches, the individual PV panels 510a, 510b need not be coplanar, nor do they need to have similar power ratings. Since the interconnections are at a relatively high voltage, wiring is inexpensive. Thus, the integrated PV module 505a, 505b approach exhibits the following advantages:

Maximization of power generated when PV panels 510a, 510b are partially shaded or otherwise not uniformly illuminated

Ability to be installed on gabled roofs or in other complex illumination environments

Ability to use widely variable PV panels 510a, 510b, or to later add additional PV panels 510a, 510b in a flexible and arbitrary way

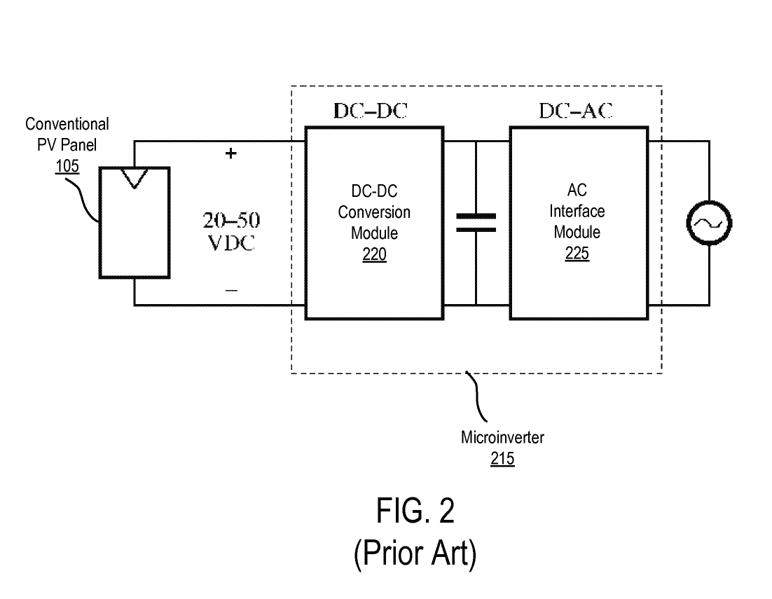

Lower cost than conventional approaches based on microinverters 215 (FIG. 2)

Simplified system interconnections (e.g., ability to add integrated PV modules 505a, 505b in parallel having PV panels 510a, 510b of varying power-generation characteristics)

Scalability to higher voltages and powers

High voltage dc bus 525 is regulated

Inverter 530 does not require dc-dc conversion circuitry

Dc-Dc Converter Design

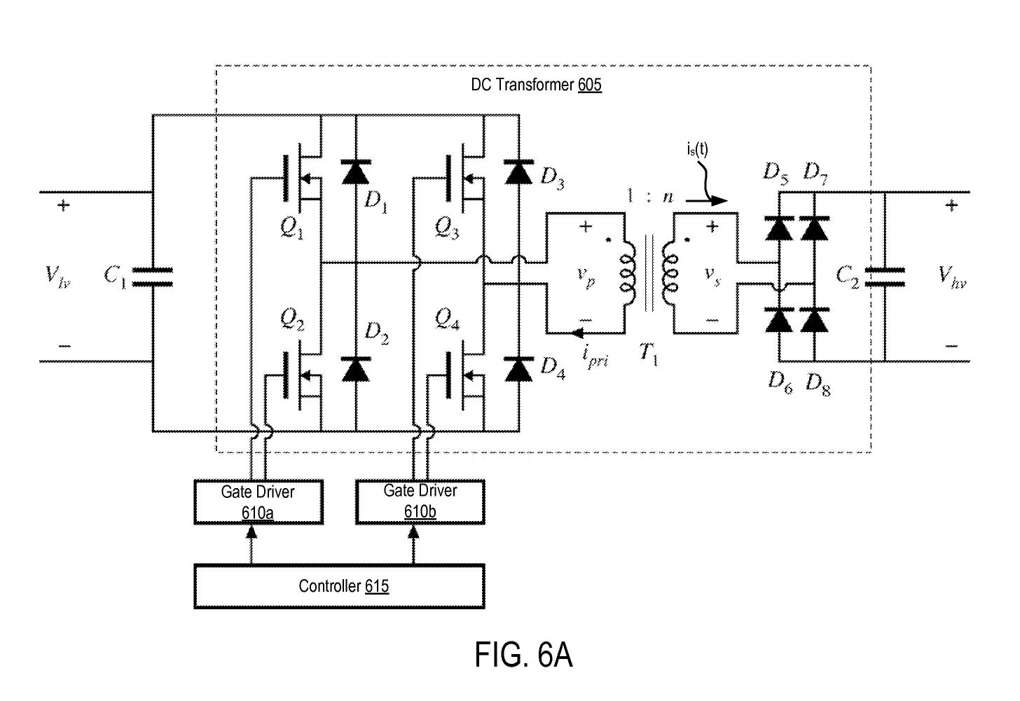

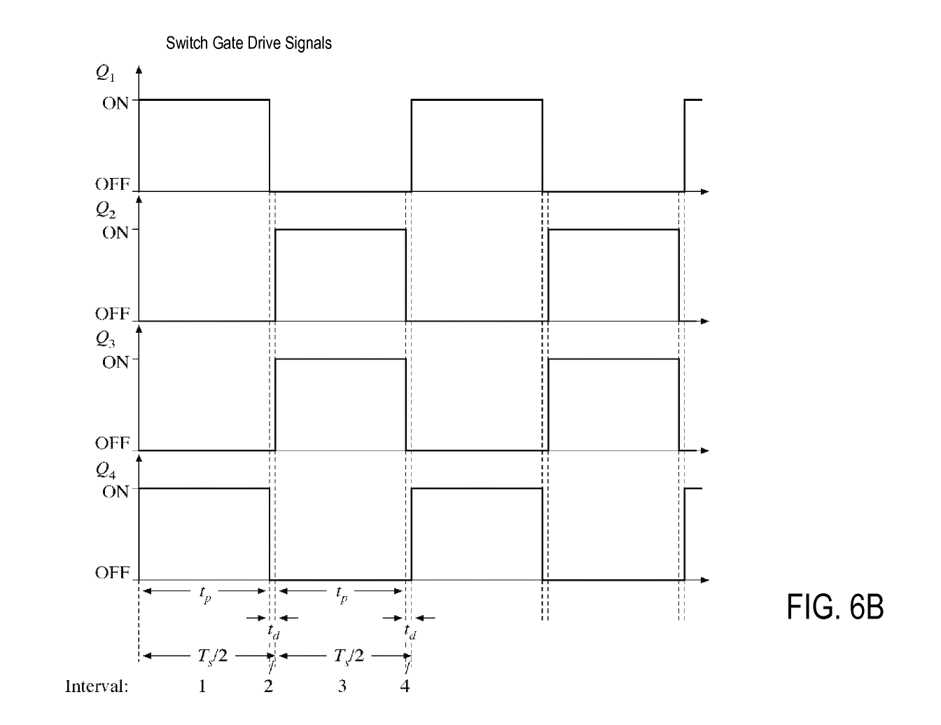

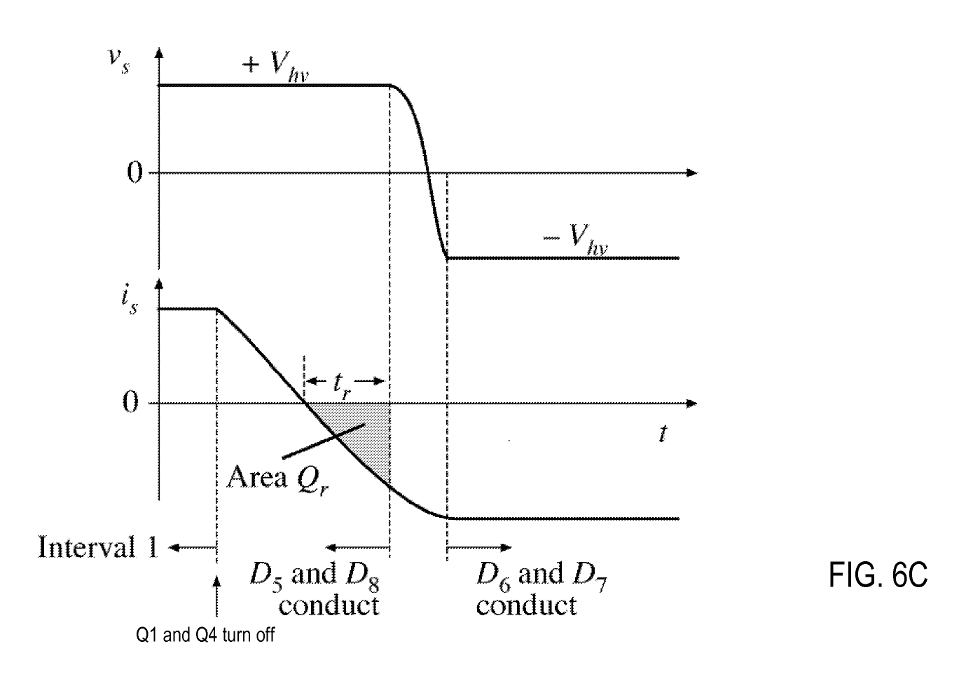

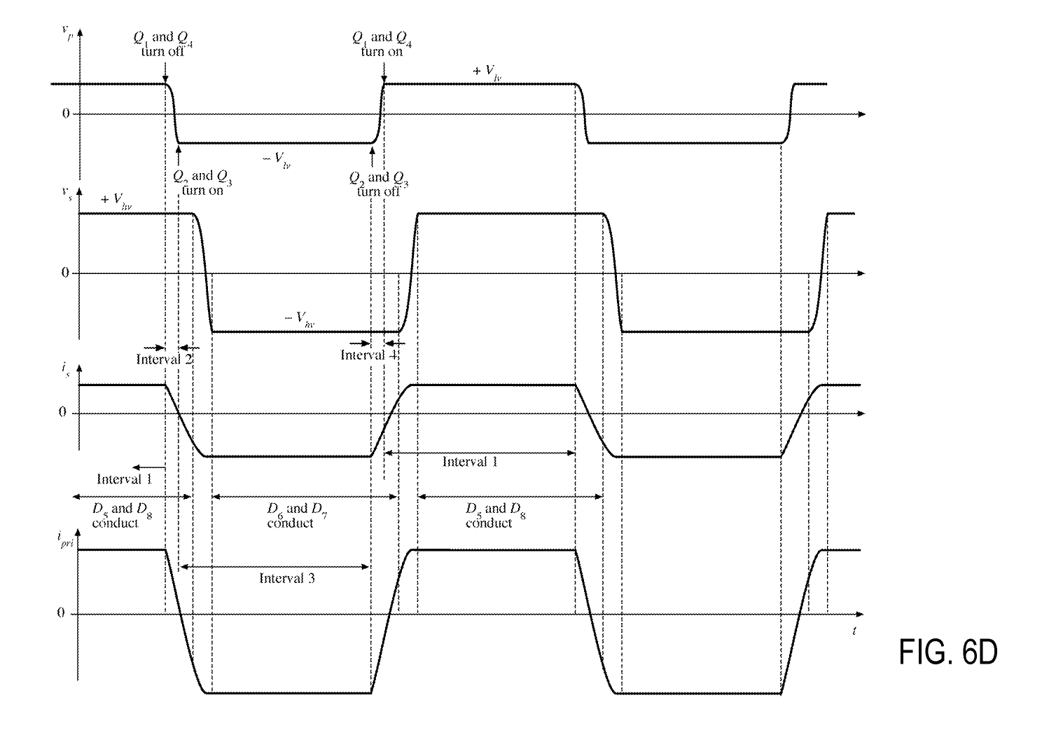

In one embodiment of the integrated PV module 505a, 505b, the dc-dc converter 515a, 515b is optimized to work with a very high efficiency and a substantially constant, fixed input-to-output voltage ratio. The dc-dc converter 515a, 515b may be implemented as a circuit referred to hereinafter as a dc transformer. One embodiment of a dc transformer circuit 605 is illustrated in FIG. 6A. The dc transformer 605 comprises a high-efficiency step-up dc-dc converter that interfaces a low-voltage solar photovoltaic panel 510a, 510b to a high-voltage dc bus 525.

One embodiment of the dc transformer 605 has been empirically observed to boost a 40 V input voltage to a 400 V output voltage with a measured 96.5% efficiency at 100 W output power. The observed circuit provides galvanic isolation. As shown in FIG. 6A, the primary-side (input-side) connection of semiconductor switching devices Q₁, Q₂, Q₃, Q₄ in the dc transformer 605 can be described as a “full bridge” or “H-bridge” configuration. In one embodiment, semiconductor switching devices Q₁, Q₂, Q₃, Q₄ are MOSFETs.

The controller 615 sends logic signals to gate drivers 610a, 610b. Based on logic signals received from the controller 615, gate driver 610a outputs signals to switching devices Q1 and Q2 and control their on/off states. Similarly, based on logic signals received from the controller 615, gate driver 610b outputs signals to switching devices Q₃ and Q₄ and control their on/off states. In one embodiment, the controller 615 begins a switching period Tₛ by sending signals to gate drivers 610a and 610b, directing them to have switching devices Q₁ and Q₄ conduct simultaneously during a first interval of duration tₚ. Typical waveforms for one embodiment of the dc transformer 605 are illustrated in FIG. 6B. As illustrated in FIG. 6B, tₚ=(Tₛ/2−t_{d}) where t_{d}, also referred to as a dead time, is a duration during which all switching devices Q₁, Q₂, Q₃, Q₄ are off.

During the first interval (Interval 1), instantaneous power is transmitted from the low-voltage input Vₗᵥ, through the H-bridge to the transformer T₁ primary winding iₚᵣᵢ. A short second interval (Interval 2) comprises a dead time of duration t_{d}. The dead time of the second interval prevents switches Q₁ and Q2 (as well as Q₃ and Q₄) from conducting simultaneously. The dead time t_{d} is typically no longer than five percent of the switching period Tₛ, thus the switches can couple the low-voltage input Vₗᵥ to the primary winding 95% of a switching cycle of the switching circuitry. During the second interval (the first dead time t_{d}), the H-bridge applies essentially zero voltage to the transformer primary winding iₚᵣᵢ, and hence negligible power is transmitted through the H-bridge to the transformer T₁. The second half of the period Tₛ, (the third and fourth intervals) is symmetrical to the first half of the period T. During the third interval, MOSFETs Q2 and Q₃ conduct simultaneously while switches Q₁ and Q₄ are off; the third interval (Interval 3) also has a duration tₚ=(Tₛ/2−t_{d}). The switching period Tₛ ends with a fourth interval (Interval 4), which is another short dead time of length t_{d} during which no switching devices Q₁, Q₂, Q₃, Q₄ conduct. The entire process repeats with switching period T.

Antiparallel diodes D₁, D₂, D₃, and D₄ are preferably the body diodes of switching devices Q₁, Q₂, Q₃, Q₄ or alternatively are Schottky diodes; these diodes conduct during the dead times t_{d} (the second and fourth intervals of FIG. 6B). Transformer T₁ is preferrably wound on a low-loss ferrite core; interleaving of windings and/or use of Litz wire minimizes the proximity losses of this device. In some embodiments of the dc transformer 605, an additional dc blocking capacitor (not shown) is inserted in series with the transformer primary winding iₚᵣᵢ to prevent saturation of the transformer core. The additional dc blocking capacitor, if inserted in series with the transformer primary winding, has a large capacitance, so that the additional dc blocking capacitor voltage has negligible ac variance. Diodes D₅, D₆, D₇, and D₈ are preferrably ultrafast diodes rated to withstand the maximum dc output voltage Vₕᵥ.

One embodiment of the dc transformer 605 has a substantially fixed ratio between the input voltage Vₗᵥ and the output voltage Vₕᵥ. For example, the output voltage Vₕᵥ may be approximately equal to Vₗᵥ, multiplied by n, where n is the turns ratio of transformer T₁. Conversely, if the output voltage Vₕᵥ is fixed (e.g., the output of the dc transformer 605 is coupled to a fixed voltage at a DC bus 525), then the input voltage Vₗᵥ is approximately equal to Vₕᵥ/n. For example, if Vₕᵥ is fixed at a voltage of 400 V dc, and a low-voltage photovoltaic panel 510 produces a nominal maximum power point voltage of 20 V, then a turns ratio of n=400/20=20 can be employed in the dc transformer 605 to set Vₗᵥ at approximately 20 V. In such a configuration, if the dc bus 525 and therefore Vₕᵥ is constant and equal to 400 V, then the photovoltaic panel 510 will operate at a voltage substantially equal to 20 V regardless of the solar irradiation of the panel 510 (though the current and therefore power generated by the panel 510 is not fixed).

In one embodiment of the integrated PV module 505, a fixed voltage conversion ratio is acceptable for the dc transformer 605 because the voltage output of the PV panel 510 is known to be within a limted range. For the sake of illustration, a typical PV cell can be considered. The current generated by a typical PV cell varies widely and is highly dependent on environmental factors such as the solar irradtion incident on the PV cell. However, a typical PV cell outputs a relatively constant DC voltage (e.g., varying over approximately a 100 mV range) that is determined primarily by the material composition of the PV cell and is largely independent of other factors such as solar irradiation. Hence, in some embodiments the PV panel 510 is known to output a relatively constant voltage based on the material properties of the PV cells included in the PV panel 510. In such embodiments, the dc transformer 605 therefore utilizes a fixed conversion ratio based on, for example, a first known voltage for the DC bus 525 and a known voltage for the output of the PV panel 510.

One embodiment of the dc transformer 605 achieves high efficiency in part through maximization of the portion of the switching period Tₛ that instantaneous power is transmitted from the low-voltage input Vₗᵥ to the transformer T₁ (through the H-bridge and any additional primary-side components). In embodiments wherein the ratio of Vₕᵥ to Vₗᵥ is substantially fixed, then the transformer turns ratio n can be chosen as noted above. This minimizes the value of n as there is no need for extra turns to accomodate a variable range of voltage conversion ratios and also minimizes the primary-side rms currents. With the exception of the small dead times of duration t_{d}, power is continuously transmitted from the low-voltage source to the transformer, either by simultaneous conduction of switches Q₁ and Q₄ during the first interval or by simultaneous conduction of switches Q₂ and Q₃ during the third interval.

Minimization of the dead time durations t_{d} minimizes the primary-side rms currents for the transformer T₁ and associated power losses. To illustrate this effect, consider the average power over a switching cyle Tₛ while assuming that the instantaneous power during the first interval (Interval 1 in FIG. 6B) is equal to the instantaneous power during the third interval (Interval 3 in FIG. 6B). The average power over the switching cyle Tₛ is slightly less that the instaneous power during the first and third intervals because the instantaneous power is zero during the dead times (Interval 2 and Interval 4 in FIG. 6B), bringing down the average. The longer the duration t_{d} of the dead times, the more the average power over the switching cyle Tₛ is reduced relative to the instaneous power during the first and third intervals. Hence, for a desired average power over the switching cyle Tₛ, minimizing the duration t_{d} of the dead times allows reduction of the instaneous power during the first and third intervals. In turn, reducing the instaneous power during the first and third intervals allows for reduction of transformer T₁ currents which minimizes the primary-side rms currents and associated power losses, thereby improving efficiency of the dc transformer 605.

In contrast to the dc transformer 605, conventional approaches for PV power generation systems utilize conventional dc-dc conversion circuitry that operates with a variable voltage ratio and, if the conventional dc-dc conversion circuitry includes a transformer, therefore must employ a transformer with a large turns ratio that would accommodate for the maximum expected value of Vₕᵥ/Vₗᵥ. To obtain other voltages, a controller for such conventional dc-dc conversion circuitry reduces the duty cycle of the circuit, i.e., the fraction of time that power is transmitted to the transformer. This leads to increased primary-side peak currents and power loss for the conventional dc-dc conversion circuitry: the reduced duty cycle increases the time when no power is transmitted to the transformer included in the conventional dc-dc conversion circuitry, and so to obtain a desired average power, the power and current must be increased during the remainder of the switching period when the switches are conducting. This increased peak power and current necessarily lead to increased losses in primary-side components for conventional dc-dc conversion circuitry.

An additional way in which one embodiment of the dc transformer 605 achieves high efficiency is through zero-voltage switching of the output-side diodes D₅, D₆, D₇, Dg. Switching loss caused by the reverse recovery process of high-voltage diodes can substantially degrade converter efficiency; hence, it is beneficial to avoid this loss mechanism in a PV power generation system. In one embodiment of the dc transformer 605, the high-voltage diodes D₅, D₆, D₇, D₈ are connected directly to output filter capacitor C₂ with no intervening filter inductor. The absence of an intervening filter inductor between the high-voltage diodes D₅, D₆, D₇, D₈ and the output fiter capacitor C₂ allows the diodes D₅, D₆, D₇, D₈ to be operated with zero voltage switching, as explained below with reference to FIG. 6C. The transformer T₁ leakage inductance limits the rate at which the diode current changes. Some embodiments of the dc transformer 605 also operate the primary-side MOSFETs Q₁, Q₂, Q₃, Q₄ with zero-voltage switching. However, since these switches Q₁, Q₂, Q₃, Q₄ operate at low voltage Vₗᵥ, their switching losses dissipate less power than the switching losses at the secondary-side diodes D₅, D₆, D₇, D₈.

FIG. 6C illustrates the transformer secondary-side voltage and current waveforms, for one embodiment of the dc transformer in which the secondary diodes D₅, D₆, D₇, D₈ operate with zero-voltage switching. The time axis is magnified to illustrate the switching of the secondary diodes D₅, D₆, D₇, D₈ during the transition lasting from the end of Interval 1 to a short time after the beginning of Interval 3. In this diagram, MOSFETs Q₁ and Q₄ and diodes D₅ and D₈ initially conduct during Interval 1. When the controller 615 commands gate drivers 610a, 610b to turn off MOSFETs Q₁ and Q₄ at the end of Interval 1 (i.e., the beginning of Interval 2), the transformer T₁ secondary current 40 begins to fall at a rate determined by the transformer T₁ leakage inductance and the applied transformer voltages. However, diodes D₅ and D₈ continue to conduct because 40 is positive. Once 40 becomes negative, the diode reverse-recovery process begins. Diodes D₅ and D₈ continue to conduct while their stored minority charge is removed by the negative current iₛ(t), and the current iₛ(t) continues to decrease. After the diode stored minority charge has been removed, diodes D₅ and D₈ become reverse-biased. The current 40 then discharges the parasitic output capacitances of the four reverse-biased diodes D₅, D₆, D₇, D₈ causing the voltage across the secondary of transformer T₁, shown in FIG. 6C as vₛ(t), to change from +Vₕᵥ to −Vₕᵥ. When vₛ(t) reaches −Vₕᵥ then diodes D₆ and D₇ become forward-biased. One manner in which some embodiments of the dc transformer 605 differ from conventional dc-dc conversion techniques is by the above-described diode zero-voltage switching process, eliminating switching losses normally induced by the diode reverse-recovery process.

Another manner in which the dc transformer 605 achieves high efficiency is through design aspects of the transformer T1 that minimize losses induced by the proximity effect. The proximity effect is a loss mechanism by which an ac current in a transformer conductor induces an eddy current in an adjacent conductor. In various embodiments, the proximity effect is minimized in transformer T₁ in part by one or more of the following design features. First, the number of windings is minimized because one embodiment of the dc transformer 605 requires only a single primary winding and a single secondary winding, with no center taps or other windings. Second, the winding geometry is optimized for minimum proximity loss using techniques such as multi-stranded (Litz) wire and interleaving of windings.

FIG. 6D illustrates the voltage and current waveforms for the primary-side and secondary-side of the transformer, for one embodiment of the dc transformer in which the secondary diodes D₅, D₆, D₇, D₈ operate with zero-voltage switching. The waveforms illustrate the switching of the secondary diodes D₅, D₆, D₇, D₈ during Intervals 1 through 4 and during subsequent intervals. Referring to FIGS. 6A and 6D together, MOSFETs Q₁ and Q₄ and diodes D₅ and D₈ initially conduct during Interval 1. When the controller 615 commands gate drivers 610a, 610b to turn off MOSFETs Q₁ and Q₄ at the end of Interval 1 (i.e., the beginning of Interval 2), the primary voltage vₚ(t) begins to decrease from +Vₗᵥ, to −Vₗᵥ and the primary current, iₚᵣᵢ(t), and the secondary current, iₛ(t), of the transformer T₁ begin to fall at a rate determined by the transformer T₁ leakage inductance and the applied transformer voltages. While the decreasing primary current iₚᵣᵢ(t) remains positive, the secondary current 40 also remains positive, causing diodes D₅ and D₈ to continue conducting. Once the primary current iₚᵣᵢ(t) and the secondary current iₛ(t) become negative, the diode reverse-recovery process begins.

During the diode reverse-recovery process, diodes D₅ and D₈ continue to conduct while their stored minority charge is removed by the negative secondary current iₛ(t), and the secondary current 40 continues to decrease. Diodes D₅ and D₈ become reverse-biased after the diode stored minority charge has been removed. The secondary current 40 then discharges the parasitic output capacitances of the four reverse-biased diodes D₅, D₆, D₇, D₈ causing the voltage across the secondary of transformer T₁, shown in FIG. 6D as vₛ(t), to change from +Vₕᵥ to −Vₕᵥ. When vₛ(t) reaches −Vₕᵥ, diodes D₆ and D₇ become forward-biased and start conducting.

When the controller 615 commands gate drivers 610a, 610b to turn off MOSFETs Q₁ and Q₄, the controller 615 initiates a resonant interval where the capacitances of MOSFETs Q₁ and Q₄ and the capacitances of diodes D₁ and D₄ are discharged by the transformer T₁ leakage inductance. Diodes D₂ and D₃ then become forward-biased, allowing the gate drivers 610a, 610b to turn on MOSFETs Q₂ and Q₃ with zero-voltage switching. The controller 615 initiates a similar resonant interval when turning off MOSFETs Q₂ and Q₃ to allow zero-voltage switching of MOSFETs Q₁ and Q₄ after forward-biasing using diodes D₁ and D₄.

When MOSFETs Q₂ and Q₃ turn off, the primary voltage vₚ(t) begins increasing from −Vₗᵥ to +Vₗᵥ, with MOSFETs Q₁ and Q₄ turning on when the primary voltage reaches +Vₗᵥ, and the primary current, iₚᵣᵢ(t), and the secondary current, iₛ(t), of the transformer T₁ also begin increasing at a rate determined by the transformer T₁ leakage inductance and the applied transformer voltages. While the increasing primary current iₚᵣᵢ(t) and increasing secondary current 40 remain negative, diodes D₆ and D₇ continue to conduct. Once the primary current iₚᵣᵢ(t) and the secondary current 40 become positive, the diode reverse-recovery process begins for diodes D₆ and D₇.

During the diode reverse-recovery process, diodes D₆ and D₇ continue to conduct while their stored minority charge is removed by the positive secondary current 40, which continues to increase. Diodes D₆ and D₇ become reverse-biased after the diode stored minority charge has been removed. The secondary current iₛ(t) then discharges the parasitic output capacitances of the four reverse-biased diodes D₅, D₆, D₇, D₈ causing the voltage across the secondary of transformer T₁, vₛ(t), to change from −Vₕᵥ to +Vₕᵥ. When vₛ(t) reaches +Vₕᵥ, diodes D₅ and D₈ become forward-biased and conduct. The above-described process is repeated over multiple cycles of the switching circuitry. The zero-voltage diode switching process for the MOSFETs Q₁, Q₂, Q₃ and Q₄ eliminates switching losses normally induced by the diode reverse-recovery process, such as losses caused by current spikes from conventional diode hard-switching techniques. Additionally, it eliminates switching losses associated with energy stored in the MOSFET output capacitances. During the dead time in switching between MOSFETs Q₁, Q₂, Q₃ and Q₄, the current of the transformer T1 leakage inductance discharges the MOSFET output capacitances and recovers their stored energies. Additional discrete inductance optionally may be added in series with the transformer to assist in this process.

Because the ratio Vₕᵥ/Vₗᵥ is substantially the same as the turns ratio of the transformer T1 and also because of the minimal dead time in switching between MOSFETs Q₁, Q₂, Q₃ and Q₄, the current waveforms of the transformer T1 result in improved efficiency. As shown by FIG. 6D, the primary current iₚᵣᵢ(t) and secondary current 40 waveforms have a trapezoidal shape that is substantially continuous without spikes or abrupt changes. Because of its trapezoidal waveform, the primary current iₚᵣᵢ(t) does not include current spikes, nor does the primary current iₚᵣᵢ(t) substantially exceed the dc input current to the dc transformer 605 coming out of the PV panel 510. Similarly, because of its trapezoidal waveform, the secondary current 40 does not include current spikes, nor does the secondary current iₛ(t) substantially exceed the dc output current from the dc transformer 605 to the dc bus 525. Consequently, the transformer T1 current waveforms exhibit minimal peak amplitudes relative to the converter power throughput, and hence the transformer losses are reduced.

Module Design

The PV panel 510a or 510b can be coupled to the input of the dc transformer 605 to form a high-voltage integrated PV module 505a or 505b. The output voltage Vₕᵥ of the dc transformer 605 will then be approximately equal to the turns ratio n of transformer T1 multiplied by the PV panel 510a, 510b output voltage. Diodes D₅-D₈ prevent reverse currents from flowing backwards from the DC bus 525 into the PV panel, and hence multiple high-voltage integrated PV modules 505a, 505b can be connected in parallel without further combiner circuits. Further, a low-cost high-voltage building-integrated photovoltaic module 505a, 505b can be constructed by co-packaging a building-integrated photovoltaic element (e.g., a PV roof shingle) with a dc transformer 605, controller 615, and gate drivers 610a, 610b.

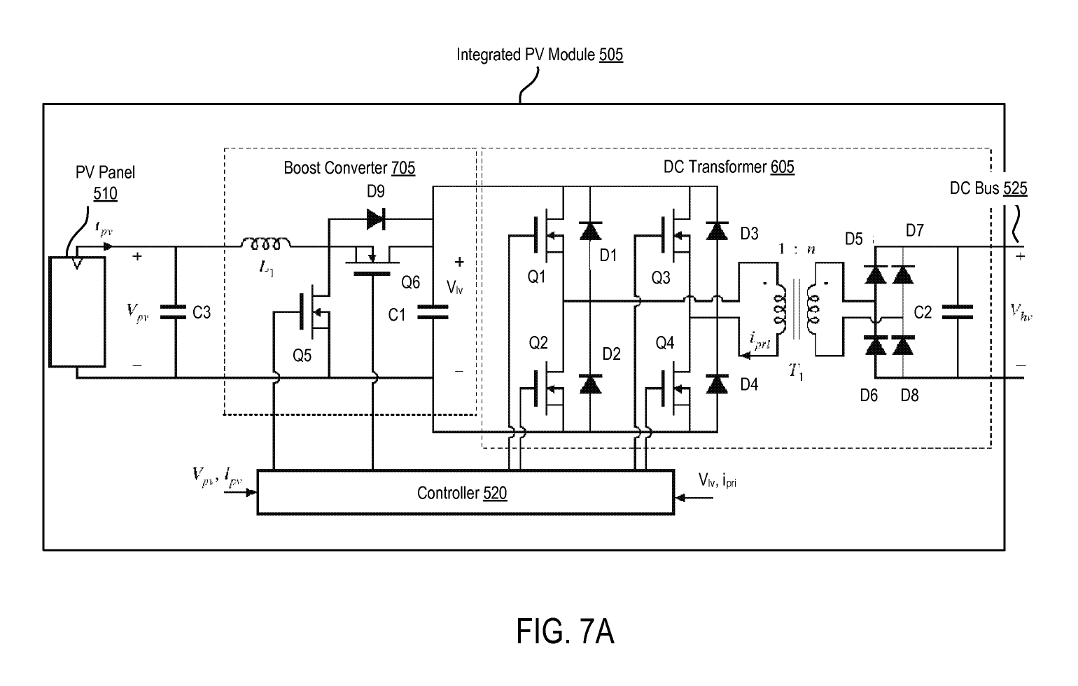

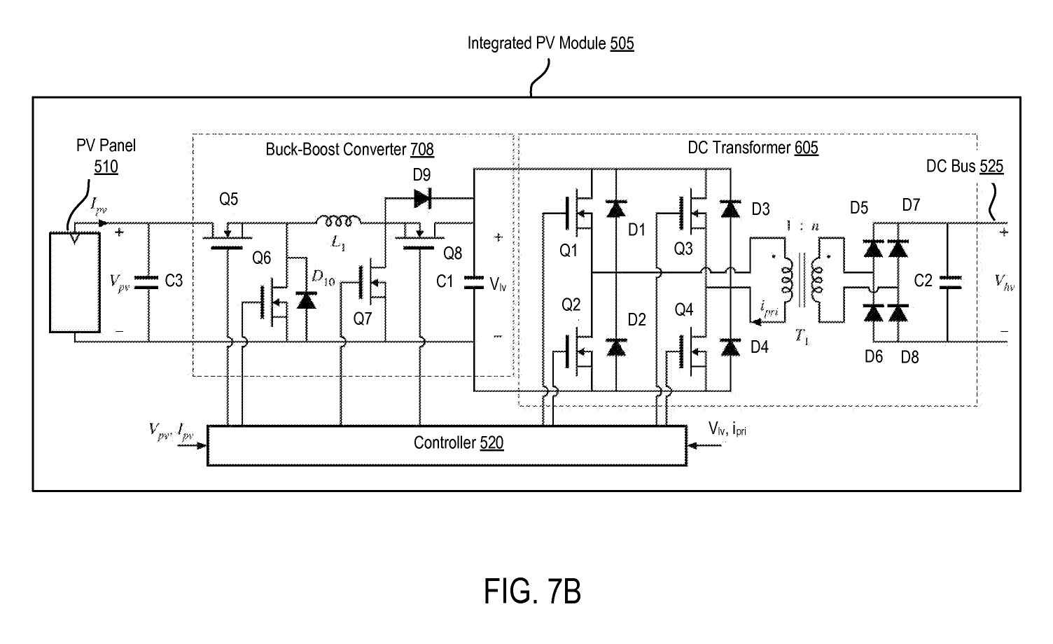

Alternatively, as shown in FIG. 7A, the PV panel 510 can be coupled to the dc transformer 605 through a dc-dc converter. FIG. 7A illustrates one embodiment of an integrated PV module 505 that includes a PV panel 510, a boost converter 705, a controller 520, and one embodiment of the dc transformer 605. The boost converter 705 is a conventional one comprising switching devices Q5 and Q6, inductor L₁, and diode D9, and is designed to produce an output voltage Vₗᵥ that is equal to or slightly greater than the maximum open-circuit voltage of the PV panel 510 (Vₚᵥ) across capacitor C3, and the dc transformer 605 circuit is designed to increase the output voltage Vₗᵥ across capacitor C1 of the boost converter 705 to the voltage Vₕᵥ on the high-voltage dc bus 525. The controller 520 operates switching device Q5 with switching frequency fₛ and duty cycle D. The controller 520 also operates switching device Q6 with a complementary drive signal, except that a small delay (a deadtime of duration t_{d}) is inserted between the turn-off transition of swtiching device Q5 and the turn-on transition of switching device Q6 to prevent simultaneous conduction of Q5 and Q6.

Other embodiments of an integrated PV module 505 can include other topologies of dc-dc converters between the PV panel 510 and the dc transformer 605. For example, FIG. 7B illustrates one embodiment of an integrated PV module 505 that includes a PV panel 510, a conventional buck-boost converter 708, a controller 520, and one embodiment of the dc transformer 605. The buck-boost converter 708 is a conventional one comprising switching devices Q5, Q6, Q7, Q8, diodes D9, D10 and an inductor L₁ coupled together as known in the art and allows the voltage from the PV panel 510 to be increased or decreased.

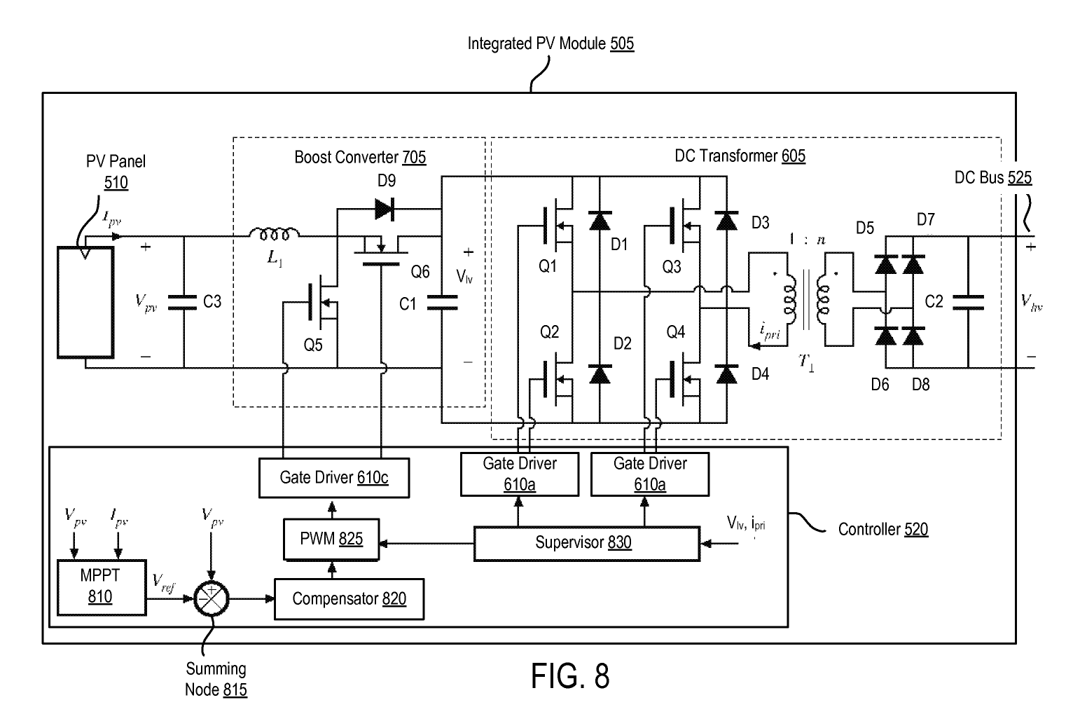

FIG. 8 illustrates one embodiment of an integraged PV module 505 that includes a boost converter 705 and provides an expanded block diagram of one embodiment of a controller 520. The PV panel 510 voltage Vₚᵥ and current Iₚᵥ are sensed by the controller 520 (connections not shown) and provided to an MPPT module 810 included in the controller 520. The MPPT module 820 produces a voltage reference V_{ref} that corresponds to the voltage of the maximum power point of the PV panel 510. A summing node 815 receives this reference and subtracts it from the sensed Vₚᵥ to produce an error signal that is input to a feedback loop compensator 820. In an alternative embodiment, the MPPT module 820 produces a current reference corresponding to the current of the maximum power point of the PV panel 510 and the summing node 815 determines a difference between the current reference and the sensed current from the PV panel 510 to produce an error signal that is input to the feedback loop compensator 820. The feedback loop compensator 820 can be a proportional-plus-integral (PI) or similar compensator known in the art of control systems. The compensator 820 outputs a control signal (e.g., duty cycle command) to the pulse-width modulator (PWM) 825 and gate driver 610c. The summing node 815, compensator 820, PWM 825, and gate driver 610c control the duty cycle of Q5 as necessary to make Vₚᵥ correspond to V_{ref}. A supervisor block 830 controls the switching of the switching devices Q1, Q2, Q3, and Q4 of the dc transformer 605 circuit as described above in reference to FIGS. 6A, 6B, 6C and 6D through gate drivers 610a, 610b. The supervisor 830 block may additionally implement limiting of the intermediate dc voltage Vₗᵥ output by the boost converter 705. The supervisor 830 can additionally implement cycle-by-cycle limiting of the peak primary current iₚᵣᵢ, to protect the integrated PV module 505 against overload conditions at the high-voltage output of the dc transformer 605 or against saturation of the transformer T₁.

The controller 520 of FIG. 8 can provide maximum power point tracking on a per-PV panel 510 basis (one controller 520 per PV panel 510). In other embodiments, the integrated PV module 505 includes multiple controllers 520, each of which provide MPPT functionality for a subset of one or more PV cells included in the PV panel 510. In such embodiments, each controller 520 is connected across the one or more backplane diodes for the one or more monitored PV cells. Also in such embodiments, the step-up ratio of the dc transformer 605 circuit (approximately the transformer T1 turns ratio n) is increased accordingly.

Fault Conditions

Referring back to FIG. 5, when the output of a PV power generation system (e.g., an AC utility grid) experiences a fault condition, the central inverter 530 operates in “anti-islanding” mode, in which the inverter 530 stops outputting power. Under these conditions, the integrated PV modules 505a, 505b cease producing power. In one embodiment, this functionality may be implemented through the use of a wired or wireless communication channel between the central inverter 530 and the integrated PV modules 505a, 505b. When the central inverter 530 commands the integrated PV modules 505a, 505b to cease producing power, then switching of all switching devices in the dc transformers 605 included in the integrated PV modules 505 is disabled. In some ebmodiments, the intermediate voltage Vₗᵥ input to the dc transformer 605 is set to a level greater than that encountered during normal system operation, providing for automatic anti-islanding control without the need for array-wide communications between the inverter 530 and the integrated PV modules 505a, 505b. When the inverter 530 enters anti-islanding mode, it allows the Vₕᵥ bus 525 voltage to rise. Hence the voltage Vᵢᵥ will also rise due to the fixed and constant conversion ratio of the dc transformer 605 and voltage limiting mode will be initiated. In this mode, if a dc-dc converter such as a boost converter 705 or a buck-boost converter 708 is included in an integrated PC module 505 as illustrated in FIGS. 7A and 7B, the MPPT function of the dc-dc converter is overridden, and the duty cycle of transistor Q5 is reduced to zero. Another alternative approach is for the supervisor 830 to disable switching of all switching devices Q1, Q2, Q3, Q4 of the dc transformer 605 when the high-voltage bus 525 exceeds a predetermined threshhold.

Upon reading this disclosure, those of skill in the art will appreciate still additional alternative structural and functional designs for a system and a process for providing an integrated PV module through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A photovoltaic power generation system including a plurality of integrated photovoltaic modules whose outputs are connected in parallel to a bus, at least one of the integrated photovoltaic modules comprising:
a photovoltaic panel configured to generate a first DC voltage at its output; and
a dc transformer configured to receive the first DC voltage and output a second DC voltage, the dc transformer including:
a transformer including a primary winding and a secondary winding;
switching circuitry coupled between the output of the photovoltaic panel and the primary winding of the transformer, the switching circuitry configured to convert the first DC voltage to a first AC voltage at the primary winding of the transformer; and
rectifier circuitry coupled between the secondary winding and the bus and configured to convert a second AC voltage across the secondary winding to the second DC voltage at the bus.

2. The photovoltaic power generation system of claim 1, wherein a ratio of the second DC voltage to the first DC voltage is substantially fixed.

3. The photovoltaic power generation system of claim 2, wherein the ratio of the second DC voltage to the first DC voltage is determined by a turns ratio of the secondary winding to the primary winding.

4. The photovoltaic power generation system of claim 1, wherein the switching circuitry is directly coupled to the primary winding of the transformer without an intervening capacitor.

5. The photovoltaic power generation system of claim 1, wherein a switching cycle of the switching circuitry includes a dead time during which the switching circuitry does not couple the first DC voltage to the primary winding.

6. The photovoltaic power generation system of claim 5, wherein the switching circuitry couples the first DC voltage to the primary winding for at least 95% of the switching cycle of the switching circuitry.

7. The photovoltaic power generation system of claim 1, wherein the rectifier circuitry is coupled directly to a shunt capacitor without an intervening inductor.

8. The photovoltaic power generation system of claim 1, wherein the photovoltaic panel is included in a building-integrated photovoltaic unit.

9. The photovoltaic power generation system of claim 8, wherein the building-integrated photovoltaic unit comprises a photovoltaic roof shingle.

10. The photovoltaic power generation system of claim 1, wherein the switching circuitry comprises a plurality of switching devices, and at least one of the switching devices is turned on to couple the output of the photovoltaic panel to the primary winding of the transformer when a voltage across said one of the switching devices is substantially zero.

11. The photovoltaic power generation system of claim 1, wherein the switching circuitry comprises a plurality of switching devices, and at least one of the switching devices is turned on to couple the output of the photovoltaic panel to the primary winding of the transformer after a diode coupled across said one of the switching devices becomes forward biased and starts conducting.

12. The photovoltaic power generation system of claim 1, wherein a switching cycle of the switching circuitry comprises a plurality of intervals, wherein:
during a first interval of the switching cycle, a first subset of switches in the switching circuitry are active to couple the output of the photovoltaic panel to the primary winding of the transformer and a voltage across the primary winding has a first voltage value;
during a second interval of the switching cycle, all switches in the switching circuitry are inactive to decouple the output of the photovoltaic panel from the primary winding of the transformer and the voltage across the primary winding transitions from the first voltage value to a second voltage value; and
during a third interval of the switching cycle, a second subset of switches in the switching circuitry are active to couple the output of the photovoltaic panel to the primary winding of the transformer, the first subset of switches in the switching circuitry are inactive and the voltage across the primary winding has the second voltage value.

13. The photovoltaic power generation system of claim 12, wherein:
during the first interval and the second interval of the switching cycle, a voltage across the secondary winding of the transformer has a third voltage value; and
during the third interval of the switching cycle, the voltage across the secondary winding of the transformer has a fourth voltage value.

14. The photovoltaic power generation system of claim 12, wherein:
during the first interval, a current across the secondary winding of the transformer has a first current value;
during the second interval, the current across the secondary winding transitions from the first current value to a second current value;
during the first interval and the second interval, a first subset of diodes in the rectifier circuit conduct to couple the secondary winding to the bus; and
during the third interval, the current across the secondary winding has the second current value, a second subset of diodes in the rectifier circuit conduct to couple the secondary winding to the bus, and the first subset of diodes in the rectifier circuit are turned off.

15. The photovoltaic power generation system of claim 14, wherein the current across the secondary winding of the transformer is substantially continuous and does not include spikes exceeding the first current value or the second current value during the first interval, the second interval and the third interval.

16. The photovoltaic power generation system of claim 1, further comprising:
a boost converter coupled between the photovoltaic panel and the dc transformer, the boost converter configured to increase the first dc voltage.

17. The photovoltaic power generation system of claim 16, wherein the boost converter is configured to increase the first dc voltage to a voltage that is substantially equal to a maximum open-circuit voltage of the photovoltaic panel.

18. The photovoltaic power generation system of claim 16, further comprising:
a controller coupled to the switching circuitry, the boost converter and to the photovoltaic panel, the controller including:
a maximum power point tracking (MPPT) module configured to detect a voltage and a current produced by the photovoltaic panel and generate a reference.

19. The photovoltaic power generation system of claim 18, wherein the reference is a voltage reference and the controller further comprises:
a feedback loop coupled to the MPPT module, the feedback loop configured to generate a control signal based on a difference between the first dc voltage and the reference, the control signal for modifying a duty cycle of the boost converter.

20. The photovoltaic power generation system of claim 18, wherein the reference is a current reference and the controller further comprises:
a feedback loop coupled to the MPPT module, the feedback loop configured to generate a control signal based on a difference between a dc current from the photovoltaic panel and the reference, the control signal for modifying a duty cycle of the boost converter.

21. The photovoltaic power generation system of claim 1, further comprising:
a buck-boost converter coupled between the photovoltaic panel and the dc transformer, the buck-boost converter configured to modify the first dc voltage.

22. A photovoltaic power generation system comprising:
a first integrated photovoltaic module including a first photovoltaic panel configured to generate a first dc voltage at its output, the output of the first photovoltaic panel coupled to a first dc transformer configured to receive the first dc voltage and generate an output dc voltage;
a second integrated photovoltaic module including a second photovoltaic panel configured to generate a second dc voltage at its output, the output of the second photovoltaic panel coupled to a second dc transformer configured to receive the second dc voltage and generate said output dc voltage, and
wherein the outputs of the first integrated photovoltaic module and the second integrated photovoltaic module are coupled in parallel to a dc bus.

23. The photovoltaic power generation system of claim 22, further comprising:
an inverter coupled to the dc bus, the inverter generating an ac voltage from said output dc voltage.

24. The photovoltaic power generation system of claim 23, wherein the first dc transformer comprises:
a transformer including a primary winding and a secondary winding;
switching circuitry coupled between the output of the first photovoltaic panel and the primary winding of the transformer, the switching circuitry configured to convert the first dc voltage to a first dc voltage at the primary winding of the transformer; and
rectifier circuitry coupled between the secondary winding and the dc bus and configured to convert a second ac voltage across the secondary winding to the output DC voltage at the dc bus.

25. The photovoltaic power generation system of claim 24, wherein a ratio of the output dc voltage to the first dc voltage is substantially fixed.

26. The photovoltaic power generation system of claim 24, wherein the switching circuitry comprises a plurality of switching devices, and at least one of the switching devices couples the output of the first photovoltaic panel to the primary winding of the transformer when a voltage across said one of the switching devices is substantially zero.

27. The photovoltaic power generation system of claim 24, wherein the switching circuitry comprises a plurality of switching devices, and at least one of the switching devices couples the output of the first photovoltaic panel to the primary winding of the transformer after a diode coupled across said one of the switching devices becomes forward biased and starts conducting.

28. The photovoltaic power generation system of claim 24, wherein a switching cycle of the switching circuitry comprises a plurality of intervals, wherein:
during a first interval of the switching cycle, a first subset of switches in the switching circuitry are active to couple the output of the first photovoltaic panel to the primary winding of the transformer and a voltage across the primary winding has a first voltage value;
during a second interval of the switching cycle, all switches in the switching circuitry are inactive to decouple the output of the first photovoltaic panel from the primary winding of the transformer and the voltage across the primary winding transitions from the first voltage value to a second voltage value; and
during a third interval of the switching cycle, a second subset of switches in the switching circuitry are active to couple the output of the first photovoltaic panel to the primary winding of the transformer, the first subset of switches in the switching circuitry are inactive and the voltage across the primary winding has the second voltage value.

29. The photovoltaic power generation system of claim 28, wherein:
during the first interval and the second interval of the switching cycle, a voltage across the secondary winding of the transformer has a third voltage value; and
during the third interval of the switching cycle, the voltage across the secondary winding of the transformer has a fourth voltage value.

30. The photovoltaic power generation system of claim 28, wherein:
during the first interval, a current across the secondary winding of the transformer has a first current value;
during the second interval, the current across the secondary winding transitions from the first current value to a second current value;
during the first interval and the second interval, a first subset of diodes in the rectifier circuit conduct to couple the secondary winding to the dc bus; and
during the third interval, the current across the secondary winding has the second current value, a second subset of diodes in the rectifier circuit conduct to couple the secondary winding to the dc bus, and the first subset of diodes in the rectifier circuit are turned off.

31. The photovoltaic power generation system of claim 30, wherein the current across the secondary winding of the transformer is substantially continuous and does not include spikes exceeding the first current value or the second current value during the first interval, the second interval and the third interval.

32. The photovoltaic power generation system of claim 22, further comprising:
a boost converter coupled between the first photovoltaic panel and the first dc transformer, the boost converter configured to increase the first dc voltage.

33. The photovoltaic power generation system of claim 32, wherein the boost converter is configured to increase the first dc voltage to a voltage that is substantially equal to a maximum open-circuit voltage of the first photovoltaic panel.

34. The photovoltaic power generation system of claim 32, further comprising:
a controller coupled to the switching circuitry, the boost converter and to the first photovoltaic panel, the controller including:
a maximum power point tracking (MPPT) module configured to detect a voltage and a current produced by the first photovoltaic panel and generate a reference.

35. The photovoltaic power generation system of claim 34, wherein the reference is a voltage reference and the controller further comprises:
a feedback loop coupled to the MPPT module, the feedback loop configured to generate a control signal based on a difference between the first dc voltage and the reference, the control signal for modifying a duty cycle of the boost converter.

36. The photovoltaic power generation system of claim 34, wherein the reference is a current reference and the controller further comprises:
a feedback loop coupled to the MPPT module, the feedback loop configured to generate a control signal based on a difference between a dc current from the first photovoltaic panel and the reference, the control signal for modifying a duty cycle of the boost converter.

37. The photovoltaic power generation system of claim 22, further comprising:
a buck-boost converter coupled between the first photovoltaic panel and the dc transformer, the buck-boost converter configured to modify the first dc voltage.
